(19) United States
(12) Patent Application Publication
(10) Pub. No.: US 2010/0210263 A1
(43) Pub. Date: Aug. 19, 2010

(54) METHOD AND DEVICE FOR MANAGING ACCESS TO A MOBILE TELECOMMUNICATION NETWORK VIA AN ACCESS NETWORK

(76) Inventor: Nasr Benali, Courbevoie (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(21) Appl. No.: 12/667,082

(22) PCT Filed: Jun. 27, 2008
(86) PCT No.: PCT/FR2008/051195

§ 371 Date: Feb. 23, 2010

(30) Foreign Application Priority Data
Jun. 29, 2007 (FR) 07 56162

(51) Int. Cl. H04W 4/00

(52) U.S. Cl. 455/435.1

(57) ABSTRACT

A method of managing access to a telecommunication network, said network comprising a core mobile network that can be accessed through at least one access network, the method comprising a step of sending, by a registration device of the access network and addressed to a core mobile network management device, following a registration of a mobile terminal with the access network performed by the registration device, a message to inform the management device of the registration carried out.

The invention relates to the field of telecommunications and more particularly to a method and a device for managing access to a mobile telecommunication network.

The invention falls within the context of telecommunication techniques allowing convergence between a mobile telecommunication network and a fixed telecommunication network. These fixed/mobile convergence techniques enable bi-mode mobile terminals, for example GSM/Wifi terminals, to access the core mobile network of the GSM network, via a Wifi local area network, and via a connection set up through the fixed network between an access point of this local area network and an interconnection device between the fixed network and the core mobile network. The point of access to the Wifi local area network for example comprises a Wifi residential gateway capable of setting up an IP (Internet Protocol) connection with the interconnection device. The access to the core mobile network via a Wifi radio local area network and the IP fixed network is an alternative access technique to the conventional UTRAN (UMTS Terrestrial Radio Access Network) or GERAN (GPRS/EDGE Radio Access Network) cellular access. The access network allowing this alternative access comprises the local area network, the access point of the local area network, the interconnection device and the link between the access point and the interconnection device. One or more access points can be connected to one and the same interconnection device so as to geographically extend the coverage of the access network. In this context, the mobile network, considered as a whole, comprises the GSM core mobile network and the access network or networks.

In the case of a GAN (Generic Access Network) type architecture, the user is connected to the core mobile network from an access network. Such a user needs to be able to benefit from the value-added services linked to his presence in the coverage area of the GAN network. For example, he needs to be able to benefit from a preferential call billing tariff associated with the GAN network or the nominal bit rate available via the GAN network, a bit rate that is generally greater than the nominal bit rate of the conventional GERAN or UTRAN access network. This presupposes being able to reliably determine whether a mobile terminal is actually served by the GAN network, or whether it is simply registered with the GAN network but not yet actually served by the GAN network. In the context of this invention, a terminal is considered to be served by the access network if a communication link with this mobile terminal set up through the core mobile network is current and set up via the access network, or if, when a request to set up such a link is sent and satisfied, this link is set up via the access network.

Now, when a mobile terminal enters into the radio coverage area of an access point of the access network, a registration request is automatically sent to a registration device of the access network, but the mobile terminal can continue to receive incoming calls from the core mobile network through the conventional GERAN access network, without passing through the GAN access network. In practice, the switch over of the access to the core mobile network, from the conventional GERAN access mode to a mode of access via the access network, is not necessarily carried out: either because the GERAN access system is designed for the in-call switchover to the access network to be prohibited, or because the mobile terminal is configured for this switchover to be conditional on the fact that its radio reception level via the local area network of the access network is greater than a minimum threshold ensuring reliable reception.

One known solution for determining the network serving a bi-mode mobile terminal is based primarily on the use of the access network registration information. It does not therefore make it possible to precisely determine whether the terminal is actually served by the access network on accessing the core mobile network.

Known alternatives to this solution relate only to the packet switching services (video on demand, mobile television) and not the circuit switching services (voice, SMS).

In practice, a first alternative consists in returning information relating to the coverage in one of the parameters of the GTP protocol, or GPRS Tunneling Protocol. This parameter is called Radio Access Technology Type (RAT type) (see 3GPP TS 29.060 Version 6 and 7). This parameter is used to identify a coverage type: UTRAN (UMTS Terrestrial Radio Access Network), GERAN (GPRS/EDGE Radio Access Network), WLAN (Wireless Local Area Network) or GAN (Generic Access Network). Although this first alternative makes it possible to detect the type of coverage in which the mobile station is located, it can be used only for the applications of the packet switching services and not the circuit switching services.

A second alternative is based on the use of the “user location information” field which contains the “cell global identity” (the identifier of the GSM cell in an operator's core mobile network). This information is returned to the network from the SGSN (Serving GPRS Support Node) concentration nodes only upon the creation of a PDP context. In the case of inter-SGSN mobility, this second alternative does not make it possible to have subscriber presence information when said subscriber is engaged in a communication session; this communication may therefore be degraded when the terminal switches from a GAN coverage to a GERAN coverage without warning the user. In order to return this information to the network and to the service platforms, the user would have to reinitiate his data session, which is not very user-friendly and does not allow him to benefit from a seamless mobility service. Furthermore, this solution can be used only for the applications of the packet switching services and not the circuit switching services.

The patent document published under the number US2004/0005886 describes a system in which an IP request to register the location of a radio terminal is transmitted to a proxy control server 131, which is part of a local IP network, forming an access network for a cellular network. This request is converted by the proxy server 131 into a terminal location registration message in accordance with a standard of the cellular network. This message is then transmitted to an MSC/VLR 121 of the cellular network in order to execute a standard terminal location registration process. The aim of this system is to propose an alternative to the GAN access networks, an alternative which uses a mechanism for converting IP requests into standard cellular network messages. It has the same drawbacks as the known GAN access networks.

The patent document published under the number EP1617697 describes a mechanism for dynamically allocating an MSC/SGSN element of a network to a mobile terminal during the registration of the terminal with the GAN network. This allocation is performed according to the GSM cell returned by the terminal to the GANC. In this way, it is possible to connect this terminal to the same MSC/SGSN as that used in a preceding allocation. The aim of this mechanism is to reduce the cost overhead, in terms of signaling in the mobile network, associated with the location data updates performed between the MSC/SGSN. It does not provide a way of remedying the abovementioned drawbacks.

One of the aims of the invention is to remedy the inadequacies and drawbacks of the state of the art and/or provide improvements thereto.

To this end, the subject of the invention is a method of managing access to a telecommunication network, said network comprising a core mobile network that can be accessed through at least one access network, the method comprising a step of sending, by a registration device of the access network and addressed to a core mobile network management device, following a registration of a mobile terminal with the access network performed by the registration device, a message to inform the management device of the registration carried out.

Symmetrically, the subject of the invention is a method of managing access to a telecommunication network, said network comprising a core mobile network that can be accessed through at least one access network, the method being implemented by a core mobile network management device and comprising a step of reception and processing of a message, originating from a registration device of said access network, the message informing the management device of a mobile terminal registration with the access network performed by said registration device.

The invention is based notably on the observation made by the inventors that the registration procedure in the access network is decorrelated from the location update procedure in the core mobile network. The returning of information relating to a mobile terminal registration performed by a registration device enables a core mobile network management device to correlate this information with the information available to the management device on the mobile terminal, notably location information. The correlation between these various items of source information makes it possible to reliably determine whether the mobile terminal is actually served by the access network upon accessing the core mobile network.

Furthermore, the invention applies equally to circuit mode communications and packet mode communications.

When the invention is applied to the GAN system, it can be used to correlate the registration information, managed in the GAN network, with location information, managed in the core mobile network and updated by the location update procedure, called “rove in”, in the GAN specifications.

According to an embodiment, the method according to the invention comprises a step of triggering, by said management device, of a search procedure in order to obtain location information relating to said mobile terminal, said triggering step being intended to be executed following said reception step. By having the search procedure triggered after the registration information has been obtained, it is possible to avoid saturating the network, unlike a solution in which this procedure would be performed constantly. This method, in effect, introduces a time synchronization between the registration carried out on the access network side and the location search procedure carried out on the core mobile network side. This effectively makes it possible to limit the time period during which the search procedure is carried out.

According to an embodiment, the method according to the invention also comprises a step of determining, according to the location information and the information relating to the registration carried out, a parameter indicating whether said mobile terminal is served by the access network. The fact that a mobile terminal is served by a network is simply deduced from location information and registration information. This determination method provides reliable knowledge as to whether a terminal is actually served by an access network. In practice, a terminal is served by a network only from the moment when its location in the access network is known to the core mobile network and used by the core mobile network to set up the communication link through the core mobile network.

Correlatively, the subject of the invention is a registration device of an access network to a core mobile network, comprising sending means so that, following a mobile terminal registration with the access network performed by the registration device, a message is sent to inform a core mobile network management device of the registration carried out.

Symmetrically, the subject of the invention is also a device for managing a core mobile network that can be accessed through an access network, comprising means of receiving and processing a message, originating from a registration device of said access network, the message informing the management device of a mobile terminal registration with the access network carried out by said registration device.

According to an embodiment, the management device according to the invention comprises means of implementing the steps of a method according to the invention, with regard to the steps implemented by the mobile network management device.

The benefits set out for the methods according to the invention can be transposed directly to the devices according to the invention.

According to a preferred implementation, the various steps of the method according to the invention are implemented by computer software or a computer program, this software comprising software instructions intended to be executed by a data processor of a mobile telecommunication network management device, respectively of an access network registration device, this program being designed to control the execution of the various steps of this method.

Consequently, the invention also targets a program, capable of being executed by a computer or by a data processor, this program comprising instructions for controlling the execution of the steps of a method as mentioned hereinabove.

This program can use any programming language and be in the form of source code, object code, or intermediate code between source code and object code, such as in a partially compiled form, or any other desirable form.

The invention also targets an information medium that can be read by a computer or data processor and comprising instructions of a program as mentioned hereinabove.

The information medium can be any entity or device capable of storing the program. For example, the medium can comprise a storage means, such as a ROM, for example a CD ROM or a microelectronic circuit ROM, or even a magnetic recording means, for example a diskette (floppy disk) or a hard disk.

Also, the information medium may be a transmissible medium such as an electrical or optical signal, which can be routed via an electrical or optical cable, by radio or by other means. The program according to the invention can in particular be downloaded over a network of the Internet type.

Alternatively, the information medium can be an integrated circuit which incorporates the program, the circuit being adapted to execute or to be used in the execution of the method concerned.

Another subject of the invention is a message, intended to be sent to a management device of a core mobile network by a registration device of an access network to said core mobile network, the message informing the management device of a mobile terminal registration with the access network carried out by the registration device.

The invention also targets an information medium that can be read by a computer or data processor and comprising a message according to the invention.

The information medium can be any hardware means, entity or device capable of storing a message. For example, the medium can comprise a storage means, such as a ROM or RAM memory, for example a CD ROM disc, or even a magnetic recording means, for example a diskette (floppy disk) or a computer hard disk.

Also, the information medium can be a medium that can be transmitted in the form of a carrier wave such as an electromagnetic signal (electrical, radio or optical signal) that can be routed via an appropriate transmission means, wired or unwired: electrical or optical cable, radio or infrared link, or by other means.

The invention also targets a method comprising a step of generation and/or use of a message according to the invention.

Other aims, features and benefits of the invention will become apparent through the following description, given purely by way of nonlimiting example, and with reference to the appended drawings in which:

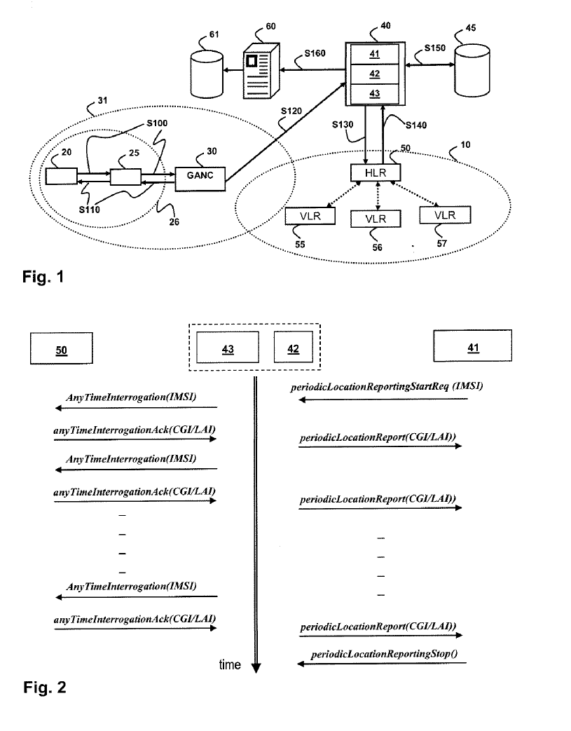

FIG. 1 diagrammatically represents a system comprising the device according to the invention and various cooperating entities;

FIG. 2 is a flow diagram of one phase of an embodiment of the method according to the invention.

The invention is described in greater detail in the exemplary case of the GAN system allowing for fixed/mobile convergence, as standardized by the 3GPP (Third Generation Partnership Project) organization.

Access to the core mobile network via an access network is an alternative access technique to the conventional UTRAN (UMTS Terrestrial Radio Access Network) or GERAN (GPRS/EDGE Radio Access Network) cellular access. This alternative technique consists in using a radio link (Wifi, Wimax, Bluetooth or other), set up between a mobile terminal and an access point, in conjunction with a link set up through a fixed network between this access point and a point of interconnection with the core mobile network, to convey, between a mobile terminal and the core mobile network, the data transmitted or received by this terminal.

Implementing a GAN network presupposes in particular the presence of the following functions:
setting up a secure and private transmission channel between a mobile terminal and an interconnection device with the core mobile network;
implementation of mechanisms for searching for and locating a mobile terminal in the GAN network;
registration of a mobile terminal with the GAN network;
management of the mobility of a mobile terminal between the GERAN or UTRAN type conventional cellular accesses and the accesses via the GAN network.

A subset of a telecommunication system allowing for fixed/mobile convergence is represented in FIG. 1.

This subset comprises:
a mobile telecommunication network 10, for example a GSM (Global System for Mobile communication) or UMTS (Universal Mobile Telecommunication System) core network; this network is also hereinafter called core mobile network;
an access network 31, called GAN network in the context of the GAN architecture;
a mobile terminal 20;
an interconnection device 30, providing the interconnection between the access network 31 and the core mobile network 10; this interconnection device 30 is called GAN access controller (GANC) in the context of the GAN architecture;
at least one access point 25 and its radio coverage area 26; this access point being able to communicate via an ADSL modem and an IP link with the interconnection device 30 with which it is associated; this access point is, for example, incorporated in a residential gateway handling the management function of the wireless local radio network, the extent of which is defined by the radio coverage area 26;
a management device 40, in the form of a gateway, for managing the mobility of the mobile terminals accessing the core mobile network 10;
a database 45, associated with the gateway 40, for storing management data identifying the location areas or cells associated with the GAN network;
a primary location device 50, cooperating with a number of secondary location devices 55, 56, 57, for locating mobile terminals in the whole of the mobile network, regardless of the access mode used;
a data management server 60, for managing presence and location data associated with the mobile terminals in the access network 31;
a database 61, associated with the gateway 60, for storing presence and location data.

The gateway 40 implements a management software application 41 which provides centralized management of the location information for the mobile terminals accessing the core mobile network 10 via the GAN access network 31. This application notably comprises functions for performing a search to locate a mobile terminal accessing the core mobile network from a GAN network.

The management application 41 is preferably compliant with the OSA (Open Service Access) architecture, defined in the GAN system, in that it offers standardized interfaces via which the functionalities of the gateway can be activated.

According to the invention, the gateway 40 also manages information relating to the terminal registrations carried out with the GAN access network. To this end, it includes specific functions, for receiving and processing a request concerning a registration made with the access network and for triggering a location search procedure following the reception of such a request.

The gateway 40 also includes a control module 43, called gsmSCF (gsm Service Control Function, an intelligent network function) which makes it possible to control, via a so-called MAP (Mobile Application Part) interface, entities of the core mobile network such as the primary location device 50.

The database 45, associated with the platform 40 and designed to be interfaced with said platform, is used to store location information relating to the access network 31. Such information is stored in the form of CGI (Cell Global Identity) code comprising an LAI (Location Area Identifier) code and a CI (Cell Identifier) code. For information, an LAI code is an identification of a location area at international level, consisting of a country code, an operator code and a code identifying an actual location area. A CI (Cell Identifier) code is an identifier of a cell of the cellular network or of the access network. The database 45 contains all the CGI (or LAI) codes of the location areas or cells associated with the GAN network. It does not contain the CGI (or LAI) codes of the location areas or cells of the conventional GERAN or UTRAN cellular network.

The presence server 60 comprises a presence and location data management software application. This application is used to collect, for a given mobile terminal, binary information concerning presence/absence on the GAN access network and, optionally, location information. This information is stored in the database 61 in association with an identifier of the mobile terminal concerned. This application is able to communicate with the management software application 41 implemented by the gateway 40 to obtain the information that it manages.

The database 61 is used to store the information collected by the presence server. In particular, it is used to store, in association, the following items:
a subscriber identifier in the mobile network, in the form of IMSI (International Mobile Subscriber Identity) code, i.e. an international identity of a subscriber inscribed in a SIM (Subscriber Identity Module) card of a mobile terminal associated with a subscriber;
location information in the GAN network for the subscriber concerned;
binary information concerning presence/absence in the GAN network of the subscriber concerned.

The primary location device 50, usually called HLR (Home Location Register) in the context of a GSM network, manages the information relating to the subscribers of an operator of the core mobile network: subscriber subscription information, services subscribed to, quality of service, location information. The location information managed by the primary location device 50 is in fact an identification of a secondary location device 55, 56, 57 managing, at a given instant, the subscriber's mobile terminal.

Each of the secondary location devices 55, 56, 57, usually called VLR (Visitor Location Register) in the context of a GSM network, manages information relating to the terminals present in its coverage area. The VLR has more precise location information than the primary location device 50, in that it knows the geographic area in which a mobile terminal is located at a given instant. This location area is usually referred to by its acronym LA, and comprises one or more cells of the cellular network. However, when a terminal is engaged in a communication via the core mobile network, the secondary location device managing this mobile terminal knows precisely which cell of the cellular network contains this terminal.

The mobile terminal 20 is a telecommunication terminal, comprising a SIM card, able to set up a communication through the core mobile network 10 and to access this core mobile network via the access network 31. It takes the form of a mobile terminal, offering a dual GSM and Wifi communication interface. This terminal must also conform to the communication standard used in the access network 31, in this case GAN standard, to be able to access the core mobile network 10 via this access network 31.

The interconnection device 30 is defined and known in the GAN system by the acronym GANC. It notably comprises functions for registering and authenticating a mobile terminal present in the coverage area of the GAN network 31. To this end, the interconnection device 30 acts as a registration device for the GAN access network. This interconnection device is connected to the core mobile network 10 and, with regard to the core mobile network, offers the conventional interfaces of a conventional controller or BSC (Base Station Controller) node. It is therefore seen by the core mobile network as a conventional BSC controller.

The interconnection device also comprises an additional interface compared to a conventional BSC controller, for communication with access points of the various local area networks of the GAN network. This interface makes it possible in particular to set up communication links in accordance with the IP protocol (Internet Protocol).

The access network 31 associated with the interconnection device 30 comprises one or more radio coverage areas, each coverage area being associated with an access point of a local radio network. Location areas or cells are defined for the GAN access network, each being identified uniquely by a CI code and an LAI code, and the set of these location areas geographically covers the various radio coverage areas of the access points of the GAN network 31. The interconnection device 30 is able to communicate with one or more access points 25 via a link compliant with the IP protocol. The set of the coverage areas of the access points with which the interconnection device 30 is able to communicate, and the connections between these access points and the interconnection device 30, are part of the GAN access network 31.

The method according to the invention is described in greater detail with respect to FIG. 1. The steps S100 to S160 of this method are executed following the entry of the mobile terminal 20 into the radio coverage area 26 of the access point 25 and after this mobile terminal 20 has obtained an IP address, an address that is assigned to it by the interconnection device 30. The procedure for obtaining this address is described in more detail in the standardization documents referenced 3GPP TS 43.318 and 44.318, available at the web address http://www.3gpp.org, these documents fully describing the progress of a procedure for registering a terminal in a GAN network.

In the step S100, the mobile terminal 20 sends the interconnection device 30 a “GA-RC Register Request” type registration request message. This is sent via the access point 25 forming a communication relay between the terminal 20 and the interconnection device 30. This message contains, among other things:
an identifier of a cell of the cellular network to which the terminal is attached when this terminal is still in the coverage area of the cellular network, or of the last location area to which the terminal was attached before leaving the coverage area of the cellular network;
an IP identifier of the Wifi access point 25 to which the mobile terminal 20 is attached;
an identification of the mobile terminal 20, in the form of an IMSI identifier.

In the step S110, if the interconnection device 30 accepts the registration request received in the step S100, it sends the mobile terminal 20 a “GA-RC Register Accept” response message. This is sent via the access point 25 forming a communication relay between the terminal 20 and the interconnection device 30. This message contains, among other things, information describing the cell of the GAN network associated with the access point 25 (color code and beacon frequency, for example), a location area identifier LAI and an identifier CI of the GAN cell. Should the registration request be rejected, the method is terminated and the following steps S120 to S160 are not executed.

In the step S120, following a successful and effective registration, the interconnection device 30 transmits to the gateway 40 a message to inform it of the registration made. This message notably comprises an identification of the terminal, in the form of an IMSI identifier, and a parameter indicating that a registration has been made. Following the reception by the gateway 40 of the message transmitted in the step S120, the gateway 40 triggers a periodic procedure to search for the location of the terminal identified in the received message. During this periodic search procedure, the steps S130 to S150 are executed in loop mode until one or more conditions for stopping this procedure are fulfilled. These stopping conditions are described in more detail hereinbelow.

In the step S130, the gateway 40 interrogates the primary location device 50 by sending it a message to request location information from the primary location device 50. For this purpose, the gateway uses an existing periodic search mechanism, as defined in the OSA architecture and in the MAP protocol. This mechanism will be described in more detail hereinbelow.

In the step S140, the primary location device 50 sends by return, after interrogating the secondary location device managing the location information for the mobile terminal 20, location information relating to the mobile terminal 20. This location information includes a location area identifier, in the form of LAI or CGI code.

In the step S150, the gateway 40 interrogates the database 45 to determine whether the location area identification received corresponds to a location area, associated with the GAN network 31. If no LAI or CGI code matching the received location area identification is found in the database 45, this means that the terminal is registered as being located in a cell or location area of the GERAN or UTRAN access network, without being served by the GAN network. Otherwise, this means that the mobile terminal has made a request to update location information concerning it with an identifier of the GAN location area following its registration with the GAN network 31 and that this terminal is served by the GAN network. In practice, until the terminal sends a request for an update of its location within the GAN access network, it cannot be served by the GAN network, nor can it receive a call through the GAN network.

In the step S160, after the periodic search procedure has been stopped, the gateway 40 generates, based on the information obtained during the last execution of the steps S130 to S150, a Boolean presence indication indicating whether or not the mobile terminal 20 is served by the GAN network. If the mobile terminal 20 is served by the GAN network, the value of this information item is for example set to 1, and set to 0 otherwise. If this information item is set to 1, the gateway sends the presence server 60 a message comprising:
an identification of the mobile terminal 20, in IMSI identifier form;
the Boolean presence information;
and the identification of the location area received from the primary location device 50.

On receiving this information, the presence server 60 stores the Boolean presence information and the identification of the location area in association with the identification of the mobile terminal 20 in the database 61. In this way, it is possible to use the identification of the mobile terminal 20 and simple interrogation of the presence server 61 to determine whether a given mobile terminal is actually served by the access network and at the same time know its location.

The location search procedure (steps S130 to S150) is a periodic interrogation procedure of variable duration. It is the management application 41 of the gateway 40 which decides to stop this procedure, and which stops the periodic location search procedure initiated in the step S130.

To avoid overloading the network during this procedure by continually sending messages between the gateway 40 and the primary location device 50, the duration of this procedure is limited. The decision to stop this procedure is made by the management application 41 of the gateway 40 following any one of the following events:
the interconnection device 30 has deregistered the mobile terminal 20, following a loss of IP connectivity between the mobile terminal 20 and the interconnection device 30 or else because the mobile terminal 20 has stopped sending a periodic message for supervising the IP communication link with the interconnection device 30;
the management application 41 of the gateway 40 has obtained, in the preceding step S140, location information corresponding to the GAN access network; in practice, in this case, this indicates that the mobile has sent a location update request and the periodic interrogation procedure is therefore no longer needed, since the mobile terminal 20 is served by the GAN network 31 from this moment;
at the end of a predefined timer duration, this duration being defined for example on the basis of the parameters of the counters defined in the GAN standard, for example the counter that manages incoming mobility, the counter that prohibits toing and froing between the GERAN network and the GAN network, etc.

In addition, when the mobile terminal 20 is switched off or leaves the coverage area 26 of the access point 25, or else is deregistered with the interconnection device 30, the interconnection device 30 transmits a message to the gateway 40 to inform it of the deregistration made. This message notably comprises an identification of the terminal, in the form of an IMSI identifier and a parameter indicating that a deregistration has been made. When the gateway 40 receives this message, the gateway no longer needs to trigger a periodic search procedure to locate the terminal identified in the received message, but generates Boolean presence information, set to 0, indicating that the mobile terminal 20 is no longer served by the GAN network. The gateway 40 sends the presence server 60 a message containing the IMSI identifier of the mobile terminal 20, the Boolean presence information, as well as a location area identifier indicating that no GAN area is associated with this mobile terminal 20 (an identifier that defaults to 0 for example). On receiving this information, the presence server 60 saves it in association with the IMSI identifier in the database 61.

As an illustrative example, one embodiment of the periodic search procedure for locating a subscriber is described in more detail hereinbelow with reference to FIG. 2. However, any other variant and different sequence of messages making it possible to obtain the same information can be envisaged.

The management application 41 of the gateway 40 initiates the periodic location search procedure by triggering the execution of the so-called “periodicLocationReportingStartReq” function (refer to the document referenced 3GPP TS 29.198-06, available at the web address http://www.3gpp.org), which provokes the sending of a corresponding request containing the identification of the subscriber in IMSI identifier form to a software module 42 of the gateway that is called mobility server (Mobility Service Capability Server or SCS, see the document referenced 3GPP TS 29.198-06).

The mobility server 42 provokes the periodic sending by the control module gsmSCF 43 of an interrogation request addressed to the primary location device 50 or HLR (see the document 3GPP TS 29.998-6-1) in order to recover subscriber location information. This request contains the IMSI identifier of the subscriber and is sent by means of the “MAP-Any-Time-Interrogation” function, defined in the document referenced 3GPP TS 29.002, the values of the parameters of this function being defined in the document referenced 3GPP TS 23.078.

On receiving the request sent by the control module, the HLR sends a second request addressed to the secondary location device or VLR which manages the mobile terminal, by means of the “MAP-PROVIDE-SUBSCRIBER-Info” message, in order to recover subscriber location information. This message contains the IMSI identifier and the object of the request (refer to the document referenced TS 23.018).

The VLR replies to the HLR with subscriber location information in the form of CGI or LAI code by using the “MAP-PROVIDE-SUBSCRIBER-Info-ack” message. Since the location information provided by a CGI code is more accurate than that provided by an LAI code, it is possible to ask the VLR to systematically return the CGI code to benefit, in all cases, from accurate location information. The HLR transmits the response to the control module gsmSCF 43 of the gateway 40, which in turn transmits it to the mobility server 42. The latter generates a response to the initial “periodicLocationReportingStartReq” request, by sending a “periodicLocationReport” message to the management application 41 of the gateway 40.

When the management application 41 of the gateway 40 decides to stop the periodic location search procedure initiated in the step S130, it uses, for example, the “periodicLocationReportingStop” function defined in the OSA architecture. The control module gsmSCF 43 of the gateway 40 then terminates the periodic sending of requests to the HLR.

The invention makes it possible to generate and manage reliable presence and location information relating to the actual use of an access network by a mobile terminal. This information can be used to implement any type of service that requires a determination as to whether a mobile terminal is actually served by an access network or knowledge of the location of a user in the access network.

It relies on standardized communication mechanisms and can thus easily be incorporated in any system compliant with the GAN standard or another standard offering a similar architecture. In particular, the invention is applicable in the case of a system using the Femto Cell 2G or 3G technology.

1. A method of managing access to a telecommunication network, said network comprising a core mobile network that can be accessed through at least one access network, the method comprising:
sending, by a registration device the access network and addressed to a core mobile network management device, following a registration of a mobile terminal with the access network performed by the registration device, a message to inform the management device of the registration carried out.

2. A method of managing access to a telecommunication network, said network comprising a core mobile network that can be accessed through at least one access network, the method being implemented by a core mobile network management device and comprising:
receiving and processing a message, originating from a registration device of said access network, the message informing the management device of a mobile terminal registration with the access network performed by said registration device.

3. The method as claimed in claim 2, further comprising:
triggering, by said management device, a search procedure in order to obtain location information relating to said mobile terminal, said triggering step being executed following said reception step.

4. The method as claimed in claim 3, also comprising:
determining, according to the location information and the information relating to the registration carried out, a parameter indicating whether said mobile terminal is served by the access network.

5. A storage medium that can be read by a data processor on which is stored a program comprising program code instructions for executing a method of managing access to a telecommunication network, said network comprising a core mobile network that can be accessed through at least one access network, the method comprising:
sending, by a registration device the access network and addressed to a core mobile network management device, following a registration of a mobile terminal with the access network performed by the registration device, a message to inform the management device of the registration carried out.

6. A storage medium that can be read by a data processor on which is stored a program comprising program code instructions for executing a method of managing access to a telecommunication network, said network comprising a core mobile network that can be accessed through at least one access network, the method being implemented by a core mobile network management device and comprising:
receiving and processing a message, originating from a registration device of said access network, the message informing the management device of a mobile terminal registration with the access network performed by said registration device; and
triggering, by said management device, a search procedure in order to obtain location information relating to said mobile terminal, said triggering step being executed following said reception step.

7. A registration device of an access network to a core mobile network, comprising:
a sender that sends, following a mobile terminal registration with the access network performed by the registration device, a message to inform a core mobile network management device of the registration carried out.

8. A device for managing a core mobile network that can be accessed through an access network, comprising:
a receiver that receives, and a processor that processes a message, originating from a registration device of said access network, the message informing the management device of a mobile terminal registration with the access network carried out by said registration device.

9. The device as claimed in claim 8, comprising: means of implementing the steps of a method as claimed in claim 2.

10. A receiver of a management device of a core mobile network that receives a message, sent to it by a registration device of an access network to said core mobile network, the message informing the management device of a mobile terminal registration with the access network carried out by the registration device.
